(19) United States
(12) Patent Application Publication
(10) Pub. No.: US 2006/0191154 A1
(43) Pub. Date: Aug. 31, 2006

(54) Method for measuring the thickness and/or length of objects and devices for this purpose

(76) Inventor: Thilo Kraemer, Darmstadt (DE)

Correspondence Address: Horst M Kasper, 13 Forest Drive, Warren, NJ, 07059, US

(21) Appl. No.: 10/549,469

(22) PCT Filed: Aug. 27, 2004
(86) PCT No.: PCT/DE04/01894

§ 371 Date: Aug. 24, 2005

(51) Int. Cl. G01B 3/22

(52) U.S. Cl. 33/832

(57) ABSTRACT

The invention relates to a method and to devices for measuring the thickness and/or length of objects (12) such as tablets, making use of a magnetic length-measuring system comprising a magnetic belt (5, 15) provided with pole pitches and with a magnetic field sensor (6, 20) located across from the magnetic belt (5, 15), having an electric evaluation circuit and having a placement surface (25) for the object (12) to be measured. The magnetic field sensor (6, 20) is mounted so as to be stationary while the magnetic belt (5, 15) is moved lengthwise past the magnetic field sensor (6, 20). A projecting arm (10, 21) is connected to the magnetic belt (5, 15) for purposes of making contact with the object to be measured, said arm accompanying the movement of the magnetic belt (5, 15), whereby the direction of movement of the magnetic belt (5, 15) is either parallel to the normal of the placement surface (25) or else it runs perpendicular thereto.

The invention relates to a method for measuring the thickness and/or length of objects having a solid or gel-like consistency, especially pharmaceutical objects such as tablets, pills or oblongs, making use of a magnetic length-measuring system comprising a magnetic belt provided with a plurality of pole pitches and with a magnetic field sensor located across from the magnetic belt, whereby the magnetic field sensor and the magnetic belt run lengthwise parallel to each other, having an electric evaluation circuit connected to the magnetic field sensor for purposes of evaluating the pulses supplied by the magnetic field sensor, and having a placement surface for the placement of the object to be measured. The invention also relates to devices for measuring the thickness and/or length of objects having a solid or gel-like consistency, especially pharmaceutical objects such as tablets, pills or oblongs.

Magnetic length-measuring systems are known that work by means of a magnetic belt with a pole pitch and with a magnetic field sensor that is mounted across from the magnetic belt. Here, the magnetic belt is stationary and the magnetic field sensor is contact-free and thus largely free of wear and impervious to dirt. The magnetic field sensor requires a cable to convey the electric pulses whereby, when the magnetic field sensor moves, the cable has to be dragged along and thus has to be suitable for a drag chain, which entails more complex material and higher costs. When the pole pitches of the magnetic belt pass the magnetic field sensor, the latter emits electric signals that are sent to an electronic evaluation circuit and counted. The electric signals of the magnetic field sensor obtained on the basis of the pole pitch of the magnetic belt are counted in the electronic evaluation circuit and transformed into a length measurement that corresponds to the pole pitch.

The company Fritz Kübler GmbH, www.kuebler.com, publication number R1002250310003ES, located in 78054 Villingen-Schwenningen, Germany has made such a linear measuring system consisting of a movable magnetic sensor and a stationary magnetic measuring belt at a pole distance of 2 mm from pole to pole, resulting in a periodical index signal every 2 mm as counting pulses. The magnetic sensor attains a resolution of 0.025 mm with a four-fold evaluation or of 0.05 mm to 0.1 mm. Thus, the succession of two adjacent counting pulses constitutes the traversing of a pre-specified path of the magnetic sensor that is determined by its resolution.

In the pharmaceutical industry, during the production of pharmaceutical objects such as tablets, pills or oblongs, various parameters of the objects, such as the weight, the bursting strength or the thickness or length, have to be checked and measured, often continuously. The measuring devices used so far for measuring the thickness or length of tablets, pills or oblongs either work too slowly or too imprecisely, or else both.

The invention is based on the objective of using a magnetic length-measuring system in a method of the above-mentioned type as well as in a device for measuring the thickness of objects having a solid or gel-like consistency, especially pharmaceutical objects such as tablets, pills or oblongs, thus rendering said method usable in said device.

The objective is achieved with a method of the above-mentioned type in that the magnetic field sensor is mounted so as to be stationary while the magnetic belt is moved lengthwise past the magnetic field sensor and a projecting arm is connected to the magnetic belt for purposes of making contact with the object to be measured, said arm accompanying the movement of the magnetic belt, whereby the direction of movement of the magnetic belt is either parallel to the normal of the placement surface of the object to be measured or else it runs perpendicular thereto.

The objective is also achieved by a device for measuring the thickness and/or the length of objects having a solid or gel-like consistency, especially pharmaceutical objects such as tablets, pills or oblongs, said device comprising a base from which a column rises vertically, and either the base or the column or both have a placement surface for the object to be measured, whereby a magnetic length-measuring system is arranged along the column and it comprises a magnetic belt provided with a plurality of pole pitches and with a stationary mounted magnetic field sensor located across from the magnetic belt as well as an electrical evaluation circuit connected to the magnetic field sensor, whereby the magnetic belt is mounted so that it can be moved along the column past the magnetic field sensor by means of a motor, while a projecting arm engages the magnetic belt, said arm being able to accompany the movement of the magnetic belt for purposes of making contact with the object to be measured.

The method and the device according to the invention have the outstanding advantage that, since the magnetic field sensor is mounted so as to be stationary while the magnetic belt is arranged so as to be movable up and down or back and forth, there is no movable cable configuration for the magnetic field sensor but rather only a mechanical movement of the magnetic belt. There is no longer a need for the cable to be suitable for a drag chain. Such an embodiment, namely, that the magnetic belt moves while the magnetic field sensor remains stationary, is best suited for the measurement of short distances, whereby the thickness measurement of such objects of the type generally encountered with pharmaceutical objects such as tablets, pills or oblongs, involves short distances to be measured. The magnetic length-measuring system here is a translatorily functioning length-measuring system.

In another embodiment of the invention, the magnetic belt is mounted on a carriage that is secured on or in the column so as to be translatorily movable lengthwise. If the magnetic belt is located inside the column, then a groove can be arranged in said column in which the carriage is secured so as to be movable up and down or back and forth.

Furthermore, the carriage can have a means that serves to move it, whereby an electric motor acts upon the device so as to move the carriage and thus the magnetic belt.

The means for moving the carriage can have teeth arranged on the side of the carriage into which a drive cog wheel meshes that can be driven by the electric motor. In an advantageous manner, when the projecting arm is lowered in the direction of the object to be measured, the drive cog wheel is disengaged from the teeth of the carriage so that the carriage moves down towards the object by virtue of the force of gravity.

Furthermore, a spring can engage with the carriage and its spring force strives to move the carriage towards the base into a resting position. In an advantageous manner, the spring is a tension spring that engages, on the one hand, with the end of the carriage facing the base and, on the other hand, with the base. This embodiment is especially advantageous if the device is to serve for length measurement and is consequently used in such a manner that the base extends vertically upwards while the column extends horizontally. Here, the placement surface for the object is situated on the column, and in this case, the normal of the placement surface of the object is perpendicular to the direction of movement of the carriage. The spring serves to pull the carriage with a defined return force in order to touch the object.

In another embodiment of the invention, the magnetic belt is a flexible loop or else it is flexible and mounted on a loop, and runs over two rollers, one of which, preferably the drive roller, is located in the area of the base while the other is arranged at the opposite end of the column. Or else the magnetic belt is arranged on a belt that is shaped into a continuous loop, whereby the belt runs over two rollers, one of which is located in the area of the base while the other is arranged at the opposite end of the column.

The objective of the invention is also achieved by a device for measuring the thickness and/or length of objects having a solid or gel-like consistency, especially pharmaceutical objects such as tablets, pills or oblongs, whereby the device consists of a base having a placement surface for the object to be measured, from which base a column rises vertically on which a magnetic length-measuring system is arranged, comprising a magnetic disk provided with a plurality of pole pitches and with a magnetic field sensor that is mounted across from the magnetic disk so as to be stationary, having an electric evaluation circuit connected to the magnetic field sensor, whereby the magnetic disk is mounted in or on the column so as to be rotated past the magnetic field sensor by means of the motor, and the rotational movement of the magnetic disk can be converted into a translatory movement by means of a linkage, while a projecting arm that serves to make contact with the object to be measured engages with the linkage, said arm being capable of accompanying the translatory movement. Consequently, the magnetic length-measuring system here is a length-measuring system that functions in a rotatory manner.

### BRIEF DESCRIPTION OF THE DRAWING IN WHICH THE FOLLOWING IS SHOWN

FIG. 1 a schematic depiction of a device for measuring the thickness and/or length of objects, whereby this device has a carriage on which a magnetic belt is mounted, and

FIG. 2 a device for measuring the thickness and/or length of objects having a magnetic belt that is designed to revolve continuously.

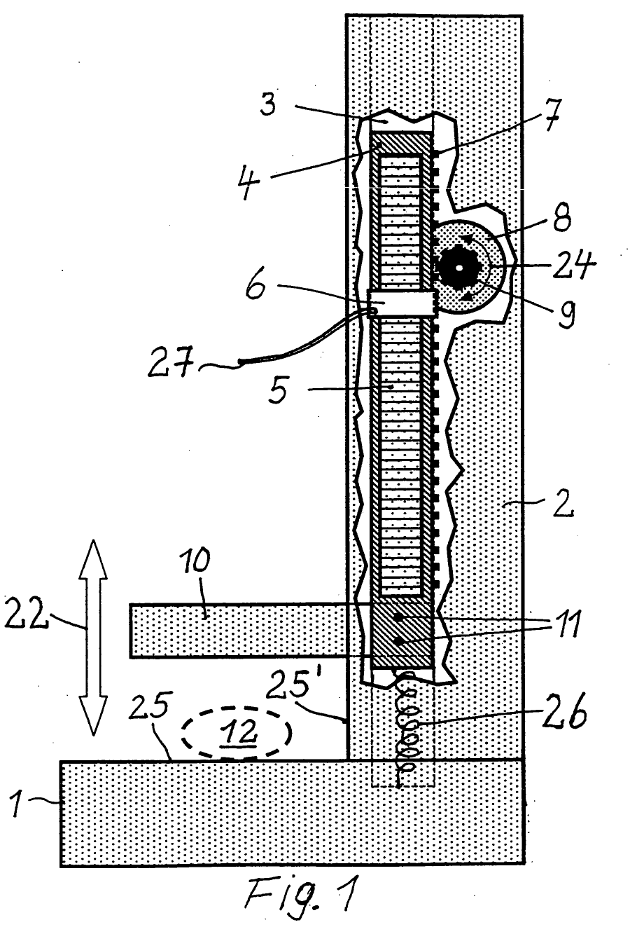

According to FIG. 1, the device for measuring the thickness and/or length of objects consists of a base 1 that, at its top, has a placement surface 25 for an object 12 that can be, for example, a tablet, a pill or an oblong. A column 2 rises vertically from the base 1, preferably perpendicular to the placement surface 25, whereby preferably the longitudinal axis of the column 2 and the normal of the placement surface 25 run parallel to each other. A carriage 4 is movably mounted on or in the column 2. Preferably, a lengthwise groove 3 can be milled into the column 2, the carriage 4 then running in said groove 3. In order for the carriage to be driven, it can have teeth 7 in which a drive cog wheel 9 meshes, said drive cog wheel 9 being driven by an electric motor 8. The rotation of the electric motor is reversible, which is shown by a curved double directional arrow 24, so that when the drive cog wheel 9 is rotated, the carriage 4 can be moved back and forth within the groove 3.

A magnetic belt 5 with a pole pitch is permanently affixed on the carriage 4 so that, when the carriage 4 moves, the magnetic belt 5 follows along. Across from the magnetic belt 5, there is a magnetic field sensor 6 which is mounted so as to be stationary, preferably on the column 2, so that, when the carriage 4 moves, the magnetic belt 5 moves past the magnetic field sensor 6 and the latter detects this movement. The magnetic field sensor 6 is connected via a cable 27 to an electric evaluation circuit (not shown here), and this evaluation circuit can also be integrated into the magnetic field sensor 6.

On the carriage 4, here at the lower end of the carriage 4, there is a projecting arm 10 that extends horizontally over the placement surface 25 of the object 12 and that is attached to the carriage 4 by means of screws 11 in such a way that the arm 10 accompanies the movements of the carriage 4. The arm 10 serves for placing or contacting the object when a thickness measurement is performed. The embodiment of the device of FIG. 1 in the position shown, namely, with a horizontally arranged base and vertically arranged column, preferably serves to measure the thickness of preferably pharmaceutical objects.

The evaluation circuit evaluates the counting pulses coming from the magnetic field sensor 6, whose number corresponds to a certain path traversed by the carriage 4 and thus by the arm 10, which can then be shown on a display.

Moreover, in an identical or similar embodiment, the device can be used for length measurement. In this case, the column 2 forms the base and it is arranged horizontally, the base 1 extending vertically upwards so that the device of FIG. 1 is rotated clockwise by 90°. Furthermore, in this case, a tension spring 26 can engage with the end of the carriage 4 facing the base 1 and with the base 1, said tension spring 26 striving to move the carriage 4, together with the projecting arm, towards the base and into a resting position.

If, for instance, as in the example shown in FIG. 1, the device with the base is horizontal and consequently the column 2 extends vertically upwards, then no tension spring or pressure spring is needed since the carriage 4 strives to move downwards due to the force of gravity.

If, in contrast, the device is being used as a length-measuring device and the base 1 is oriented vertically and the column 2 is oriented horizontally, then another placement surface 25′ can be provided on the column 2 in order to measure the length of an object. Then the normal of the placement surface 25′ runs perpendicular to the longitudinal axis of the carriage 4 or of the magnetic belt 5, which moves horizontally. In this case, it is advantageous to install a tension spring between the end of the carriage 4 facing the base 1 and the base since the tension spring 26 strives to move the carriage 4 towards the base 1 into a resting position and thus towards the object. Here, for the object, the projecting arm 10 forms a stop jaw that extends vertically upwards.

For this reason, the device of FIG. 1 can also be rotated clockwise by 90° without a need for further manipulations in order to consecutively determine the thickness and length of an object.

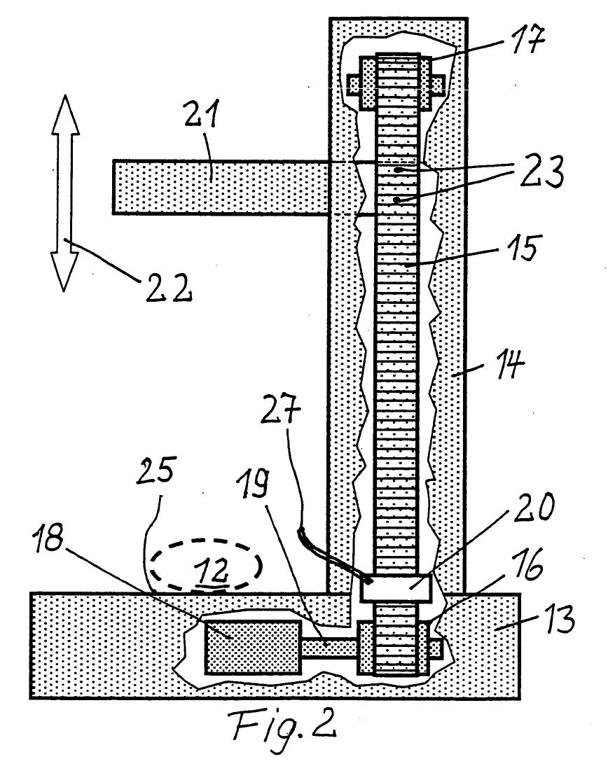

FIG. 2 shows another example of a device according to the invention preferably for measuring the thickness of an object 12. On a preferably horizontally arranged base 13, a column 14 rises perpendicularly and thus preferably vertically to the base 13, whereby the longitudinal axis of the column 14 is oriented parallel to the normal of a placement surface 25 for the object 12. In the base 13, there is a first or lower roller 16—mounted on a drive shaft 19—which can be driven by means of an electric motor 18, while it carries the roller 16 along. At the upper end of the column 14, a second or upper roller 17 is rotatably mounted, whereby a continuous belt 15 is wrapped around the two rollers 16, 17. The belt 15 can either be a magnetic belt provided with pole pitches or else the belt 15 can be a flexible steel or plastic belt onto which, at least partially in the lengthwise direction of the belt 15, a magnetic belt with a pole pitch has been applied which is thus translatorily movable.

Moreover, for the object 12, an arm 21 projects horizontally beyond the placement surface 25, whereby the arm 21 is attached to the belt 15 by means of screws 23. A stationary magnetic field sensor 20 is mounted across from the magnetic belt 15.

When the lower drive roller 16 is rotated by means of the electric motor 18, the magnetic belt 15 runs past the magnetic field sensor 20, carrying along the arm 21, so that, as described above for FIG. 1, the magnetic field sensor supplies electric-magnetic counting pulses that, in turn, can be evaluated and processed in an evaluation circuit, as a result of which the thickness of the object 12 can be measured. The device shown in FIG. 2 can also be used when it is rotated clockwise by 90°, so that in this case, the length of an object can also be measured.

### INDUSTRIAL APPLICABILITY

The invention is industrially applicable especially in the pharmaceutical sector for measuring the thickness and/or length of tablets, pills or oblongs. Due to the high precision of the currently available magnetic length-measuring systems, such pharmaceutical products can be measured very accurately in terms of their thickness and/or length, whereby the embodiment of the invention with a movable carriage or with a movable continuous belt, which carries the magnetic belt, allows a very fast measurement procedure.

### LIST OF REFERENCE NUMERALS

1, 13 base
2, 14 column
3 groove
4 carriage
5, 15 magnetic belt
6, 20 magnetic field sensor
7 teeth
8, 18 electric motor
9 drive cog wheel
10, 21 arm
11, 23 screws
12 object
16, 17 rollers
19 drive shaft
22, 24 double directional arrow
25, 25′ placement surface for the object
26 tension spring
27 cable

1. A method for measuring the thickness and/or iength of objects (12) having a solid or gel-like consistency, especially pharmaceutical objects such as tablets, pills or oblongs, making use of a magnetic length-measuring system comprising a magnetic belt (5, 15) provided with a plurality of pole pitches and with a magnetic field sensor (6, 20) located across from the magnetic belt (5, 15), whereby the magnetic field sensor (6, 20) and the magnetic belt (5, 15) run lengthwise parallel to each other, having an electric evaluation circuit connected to the magnetic field sensor (6, 20) for purposes of evaluating the pulses supplied by the magnetic field sensor (6, 20), and having a placement surface (25) for the object (12) to be measured, characterized in that
the magnetic field sensor (6, 26) is mounted so as to be stationary while the magnetic belt (5, 15) is moved lengthwise past the magnetic field sensor (6, 20) and a projecting arm (10, 21) is connected to the magnetic belt (5, 15) for purposes of making contact with the object to be measured, said arm accompanying the movement of the magnetic belt (5, 15), whereby the direction of movement of the magnetic belt (5, 15) is either parallel to the normal of the placement surface (25) of the object (12) to be measured or else it runs perpendicular thereto.

2. A device for measuring the thickness and/or the length of objects (12) having a solid or gel-like consistency, especially pharmaceutical objects such as tablets, pills or oblongs, characterized in that the device comprises a base (1, 13) from which a column (2, 14) rises vertically, and either the base or the column (2, 14) or both have a placement surface (25, 25′) for the object (12) to be measured, whereby a magnetic length-measuring system is arranged along the column (2, 14) and it comprises a magnetic belt. (5, 15) provided with a plurality of pole pitches and with a stationary mounted magnetic field sensor located across from the magnetic belt (5, 15) as well as an electrical evaluation circuit connected to the magnetic field sensor (6, 20), whereby the magnetic belt (5, 15) is mounted so that it can be moved along the column (2, 14) past the magnetic field sensor (6, 20) by means of a motor, while a projecting arm (10, 21) engages the magnetic belt (5, 15), said arm being able to accompany the movement of the magnetic belt (5, 15) for purposes of making contact with the object to be measured.

3. The device according to claim 2, characterized in that the magnetic belt (5) is mounted an a carriage (4) that is secured an or in the column (2) so as to be movable lengthwise.

4. The device according to claim 3, characterized in that, inside the column (2), there is a groove (3) in which the carriage (4) is secured so as to be movable up and down or back and forth.

5. The device according to claim 2, characterized in that,
in order for the carriage (4) to be moved, it has a movement means (7), whereby an electric motor (8) that serves to move the carriage (4) and thus the magnetic belt (5) is capable of acting upon the movement means (7).

6. The device according to claim 5, characterized in that the movement means has teeth (7) arranged an the side of the carriage (4) into which a drive cog wheel (9) meshes that can be driven by the electric motor (8).

7. The device according to claim 2 characterized in that
a spring (26) engages with the carriage (4) and its spring force strives to move the carriage (4) towards the base (1) into a resting position.

8. The device according to claim 9, characterized in that
the spring (26) is a tension spring that engages, an the one hand, with the end of the carriage (4) facing the base and, an the other hand, with the base (1).

9. The device according to claim 2, characterized in that
the magnetic belt (15) is shaped into a loop and runs over two rollers (16, 17), one of which (16) is located in the area of the base (13) while the other (17) is arranged at the opposite end of the column (14).

10. The device according to claim 2, characterized in that
the magnetic belt (15) is arranged an a belt that is shaped into a continuous loop, whereby the belt runs over two rollers (16, 17), one of which (16) is located in the area of the base (13) while the other (17) is arranged at the opposite end of the column (14).

11. A device for measuring the thickness and/or length of objects having a solid or gel-like consistency, especially pharmaceutical objects such as tablets, pills or oblongs, characterized in that
said device consists of a base having a placement surface for the object to be measured, from which base a column rises vertically an which a magnetic length-measuring system is arranged, comprising a magnetic disk provided with a plurality of pole pitches and with a magnetic field sensor that is mounted across from the magnetic disk so as to be stationary, and having an electric evaluation circuit connected to the magnetic field sensor, whereby the magnetic disk is mounted in or an the column so as to be rotated past the magnetic field sensor by means of the motor, and the rotational movement of the magnetic disk can be converted into a translatory movement by means of a linkage, while a projecting arm that serves to make contact with the object to be measured engages with the linkage, said arm being capable of accompanying the translatory movement.
